(19) United States
(12) Patent Application Publication
(10) Pub. No.: US 2025/0256783 A1
(43) Pub. Date: Aug. 14, 2025

(54) SIDE STRUCTURE OF CARGO BOX OF VEHICLE

(71) Applicants: Hyundai Motor Company, Seoul (KR); Kia Corporation, Seoul (KR)

(72) Inventors: Woo-Been BYEON, Hwaseong-Si (KR); Jun-Young PARK, Hwaseong-Si (KR)

(73) Assignees: Hyundai Motor Company, Seoul (KR); Kia Corporation, Seoul (KR)

(21) Appl. No.: 18/824,601

(22) Filed: Sep. 4, 2024

(30) Foreign Application Priority Data
Feb. 13, 2024 (KR) 10-2024-0020492

(51) Int. Cl. B62D 33/02

(52) U.S. Cl. CPC B62D 33/02

(57) ABSTRACT

A side structure of a cargo box of a vehicle includes a side external panel mounted outside the cargo box to form an exterior of the cargo box provided at the rear of a cabin in which occupants get on in the vehicle, a side internal panel mounted inside the side external panel in the cargo box, and a side upper member disposed in a longitudinal direction of the vehicle at an upper end portion of the side external panel or an upper end portion of the side internal panel, in which upper end portions of reinforcement members mounted between the side external panel and the side internal panel are connected to the side upper member.

### CROSS-REFERENCE TO RELATED APPLICATION

The present application claims priority to Korean Patent Application No. 10-2024-0020492, filed on Feb. 13, 2024, the entire contents of which is incorporated herein for all purposes by this reference.

### BACKGROUND OF THE PRESENT DISCLOSURE

### Field of the Present Disclosure

The present disclosure relates to a side structure of a cargo box of a vehicle, in which rigidity of an upper side portion of the cargo box of the vehicle is improved.

### Description of Related Art

In vehicles such as pickup trucks, a cabin for accommodating passengers is formed at the front of the vehicle, and a cargo box for loading or unloading cargo is formed at the rear of the vehicle.

In frame body type pickup trucks, a cabin 12 and a cargo box 13 are disposed above the frame 11 which extends in a longitudinal direction of the vehicle 1 (see FIG. 1).

The cargo box 13 includes a plurality of members which become a structure between an external panel 13a and an internal panel, and these members are connected so that the cargo box 13 has rigidity.

However, in a cargo box 13 of the vehicle 1 according to the related art, there are portions in which the members are not connected to each other, and there is a problem in that rigidity is reduced in these portions.

For example, because the members are not connected on the upper side portion of the cargo box 13, there is a problem in that, when a load is applied to the upper side portion of the cargo box 13 due to a collision or the like, the upper side portion of the cargo box 13 is damaged.

### BRIEF SUMMARY

Various aspects of the present disclosure are directed to providing a side structure of a cargo box of a vehicle, in which rigidity of an upper end portion of the cargo box of the vehicle is improved.

To achieve the object, a side structure of a cargo box of a vehicle including a cabin where occupants board according to an exemplary embodiment of the present disclosure may include a side external panel mounted outside the cargo box to form an exterior of the cargo box provided behind the cabin, a side internal panel mounted inside the side external panel in the cargo box, a side upper member mounted in a longitudinal direction of the vehicle on an upper end portion of the side external panel or an upper end portion of the side internal panel, and a plurality of reinforcement members mounted between the side external panel and the side internal panel, wherein upper end portions of reinforcement members are connected to the side upper member.

The side upper member may include an open lower portion.

The side upper member may be formed to include a cross section in which an upper portion and first and second side portions of the side upper member are bent at a right angle.

The plurality of reinforcement member may include a front side member mounted at a front end portion of a side portion of the cargo box, and an upper end portion of the front side member may be connected to a front end portion of the side upper member.

A lower end portion of the front side member may be connected to each of first and second end portions of a first floor member mounted at a lower end portion of a front portion of the cargo box.

The side structure of the cargo box of the vehicle may further include a second floor member spaced apart from the first floor member to a rear side of the vehicle and connected to a wheel house.

The plurality of reinforcement member may include a third floor member including a middle portion formed in a width direction of the cargo box and disposed on a floor of the cargo box, and formed to be bent upward between the side external panel and the side internal panel, and an upper end portion of the third floor member may be connected to the side upper member.

A hook rail may be further provided in the longitudinal direction of the vehicle under the side upper member, and a lower end portion of the side upper member, the upper end portion of the third floor member, and the upper end portion of the side internal panel may be connected to the hook rail.

The plurality of reinforcement member may include a D post on which a tail gate is provided at the rear end portion of the cargo box, and an upper end portion of the D post may be connected to a rear end portion of the side upper member.

A lower end portion of the D post may be connected to an end portion of a fourth floor member mounted in a width direction of the vehicle at a lower end portion of a rear portion of the cargo box.

The side structure of the cargo box of the vehicle may further include a front guard disposed in a width direction of the vehicle at an upper end portion of a front portion of the cargo box and including first and second end portions each connected to the side upper member.

According to the side structure of the cargo box of the vehicle according to an exemplary embodiment of the present disclosure including the above configuration, because the side upper member is provided inside the upper portion of the cargo box of the vehicle and the side upper member is connected to other rigid members provided at the side portion and the lower portion of the cargo box, it is possible to improve the rigidity of the upper side portion of the cargo box.

Therefore, even when the load is applied to the upper side portion of the cargo box due to a collision or the like, it is possible to prevent or minimize the deformation of the upper side portion of the cargo box.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a side view showing a frame body type pickup truck in the related art.

FIG. 2 is a perspective view showing a cargo box of a vehicle to which a side structure of the cargo box according to an exemplary embodiment of the present disclosure is applied.

FIG. 3 is a front view showing an internal side of the cargo box of the vehicle to which the side structure of the cargo box of the vehicle according to an exemplary embodiment of the present disclosure is applied.

FIG. 4 is a front view showing an external side of the cargo box of the vehicle to which the side structure of the cargo box of the vehicle according to an exemplary embodiment of the present disclosure is applied.

FIG. 5 is a cross-sectional view along line I-I in FIG. 4.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a side structure of a cargo box of a vehicle according to an exemplary embodiment of the present disclosure will be described in detail with reference to the accompanying drawings.

The side structure of the cargo box of the vehicle according to an exemplary embodiment of the present disclosure may include a side external panel 21 provided outside a cargo box 13 to form an exterior of the cargo box 13 provided at the rear of a cabin 12 in which occupants get on in a vehicle 1, a side internal panel 22 provided inside the side external panel 21 in the cargo box 13, a side upper member 32 disposed in a longitudinal direction of the vehicle 1 at an upper end portion of the side external panel 21 or an upper end portion of the side internal panel 22, and a plurality of reinforcement members 33, 34, and 37 disposed between the side external panel 21 and the side internal panel 22, in which upper end portions of the reinforcement members 33, 34, and 37 are connected to the side upper member 32.

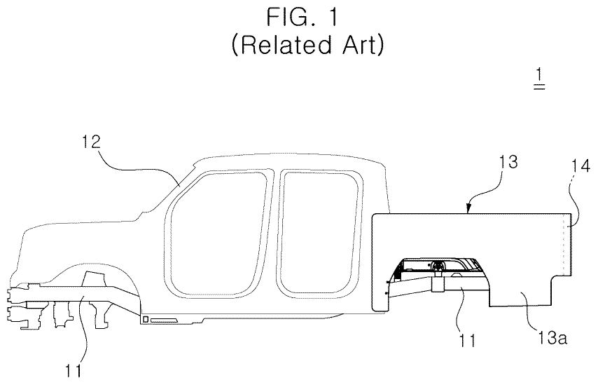

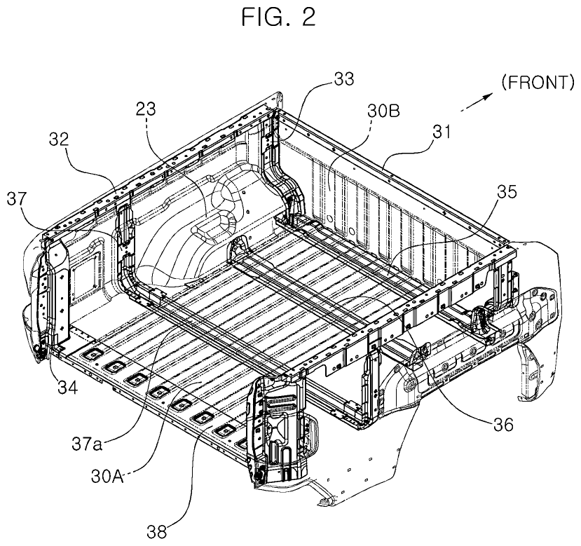

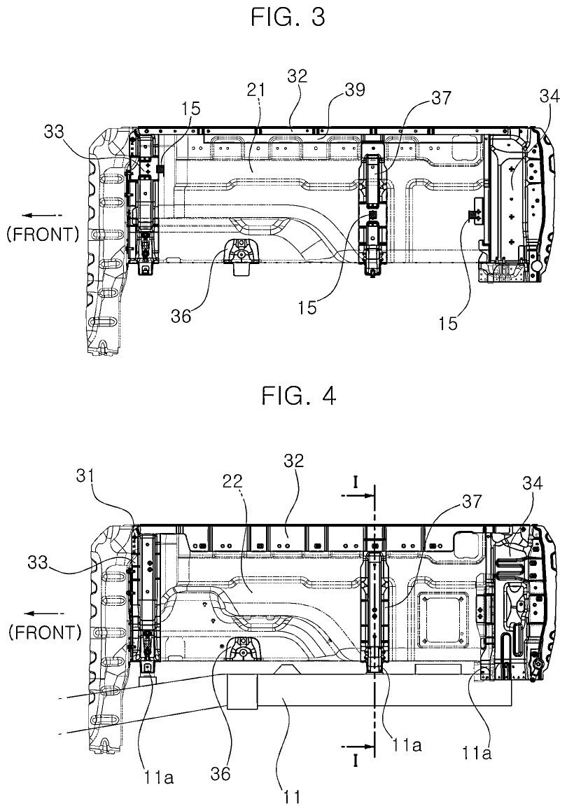

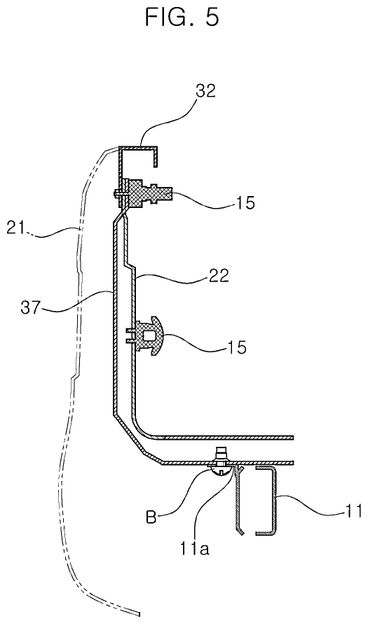

FIG. 2 shows a side structure of a cargo box of a vehicle according to an exemplary embodiment of the present disclosure. Referring back to FIG. 1, in the vehicle 1 such as a pickup truck, the cabin 12 in which occupants get on and the cargo box 13 for loading or unloading cargo at the rear of the cabin 12 are provided above a frame 11 which extends in a longitudinal direction of the vehicle 1.

The side structure of a cargo box of a vehicle according to an exemplary embodiment of the present disclosure may be applied to the cargo box 13 of a small truck such as a pickup truck.

A side portion of the cargo box 13 may be formed using the side external panel 21 and the side internal panel 22.

The side external panel 21 may be provided outside the cargo box 13 to form the exterior of the cargo box 13.

The side internal panel 22 may be provided inside the side external panel 21.

The side external panel 21 and the side internal panel 22 may be disposed at intervals, and their upper end portions may be fastened.

Here, referring to FIG. 2, a floor panel 30A on which the cargo is loaded and forms a floor of the cargo box 13, a front panel 30B for closing a front end portion of the cargo box 13, and a tailgate 14 to be opened or closed at a rear end portion of the cargo box 13 may be provided to provide a basic shape of the cargo box 13.

Furthermore, members configured for reinforcing the rigidity of the cargo box 13 may be additionally applied to increase the rigidity of the cargo box 13. For the members applied to reinforce rigidity, the rigidity of an individual member may be increased by bending a metal plate in a direction perpendicular to a longitudinal direction or forming a closed cross-sectional structure, and by adopting the same, the rigidity of the cargo box 13 may be reinforced.

Meanwhile, hereinafter, when two members are fastened, it means that the members may be fastened using welding W or a bolt B.

In an exemplary embodiment of the present disclosure, by additionally installing members configured for providing rigidity to increase the rigidity of the cargo box 13 and fastening the members to each other, it is possible to increase the rigidity of the cargo box 13.

The side upper member 32 may be provided at an upper end portion of the side portion of the cargo box 13.

The side upper member 32 may be disposed in the longitudinal direction of the vehicle 1 at the upper end portion of the side external panel 21 or the upper end portion of the side internal panel 22.

Because the side upper member 32 needs a configuration to provide rigidity against an external force, when looking at its cross section, the side upper member 32 may be formed to include a shape in which a lower portion may be open and upper portion and first and second side portions are bent at a right angle.

In a state in which the side upper member 32 is provided at the upper end portion of the side portion of the cargo box 13, the plurality of reinforcement members 33, 34, and 37 may be additionally disposed to be perpendicular to the ground between the side external panel 21 and the side internal panel 22, and each upper end portion of the reinforcement members 33, 34, and 37 may be connected to the side upper member 32.

Because the side upper member 32 provided at the upper end portion of the side portion of the cargo box 13 is supported by the reinforcement members 33, 34, and 37, even when an external force such as a collision is applied to the upper end portion of the cargo box 13, it is possible to prevent or minimize the deformation of the upper end portion of the side portion of the cargo box 13.

Conventionally, the side portion of the cargo box may be simply including the side external panel and the side internal panel, resulting in insufficient rigidity against the collision.

Meanwhile, even when the side upper member 32 is provided, in a case that the side upper member 32 is not properly supported, the side upper member 32 does not function as a rigid member, but in an exemplary embodiment of the present disclosure, the reinforcement members 33, 34, and 37 may be connected to the side upper member 32 and support the side upper member 32 itself, so that the side upper member 32 may function as a rigid member.

A front side member 33 provided at a front end portion of the side portion of the cargo box 13 may become one of the plurality of reinforcement members 33, 34, and 37.

The front side member 33 may be provided at the front end portion of the side portion of the cargo box 13 in a substantially vertical direction thereof. In FIG. 2, a lower portion of the front side member 33 may be shown in a shape which is convex to the inside of the cargo box 13 by a wheel house 23. The front side member 33 may be disposed to connect upper and lower end portions at the front end portion of the side portion of the cargo box 13 by processing a plate.

An upper end portion of the front side member 33 may be connected to a front end portion of the side upper member 32. Therefore, the front end portion of the side portion of the cargo box 13 includes a structure in which the side upper member 32 and the front side member 33 may be connected to each other.

Meanwhile, a lower end portion of the front side member 33 may be connected to each of both end portions of a first floor member 35 disposed at a lower end portion of a front portion of the cargo box 13. The floor of the cargo box 13 may be provided with a plurality of floor members 35, 36, 37, and 38 formed in a width direction of the vehicle 1 in the longitudinal direction of the vehicle 1 or formed in the width direction of the vehicle 1 and then extending upward along the cargo box 13 at both end portions of the floor. Among them, the first floor member 35 may be disposed at the frontmost portion and has both end portions connected to the lower end portion of the front side member 33. Therefore, a ‘U’-shaped structure may be formed at the front end portion of the cargo box 13 by the front side member 33 and the first floor member 35 and may support the front end portion of the side upper member 32.

At a position spaced apart from the first floor member 35 to the rear of the vehicle 1, the second floor member 36 may be disposed in the width direction of the vehicle 1. Both end portions of the second floor member 36 may be each connected to the wheel house 23 of the vehicle 1. The second floor member 36 may support both end portions of the cargo box 13 at a portion in which the wheel house 23 is formed.

In the cargo box 13, as one of the plurality of reinforcement members 33, 34, and 37, the third floor member 37 may be provided from the second floor member 36 to the rear of the vehicle 1. The third floor member 37 includes a middle portion 37a disposed on the floor of the cargo box 13 in the width direction of the vehicle 1 and may be formed to be bent upward between the side external panel 21 and the side internal panel 22. Both end portions of the third floor member 37, that is, upper end portions of the portion extending upward between the side external panel 21 and the side internal panel 22 may be connected to the side upper member 32. The third floor member 37 may be formed in a “U” shape and has both end portions connected to the side upper member 32 so that a middle portion of the side upper member 32 is supported by the third floor member 37.

The third floor member 37 may be connected to the frame 11 using a frame mount 11a. In other words, the frame mount 11a may be provided on the frame 11, and by use of the frame mount 11a, the third floor member 37 may be connected to the frame 11.

The plurality of reinforcement members 33, 34, and 37 may include a D post 34 and the fourth floor member 38 provided at the rear end portion of the cargo box 13.

The D post 34 may be a member in which the tailgate 14 is provided at the rear end portion of the cargo box 13 and may be provided in a state of being perpendicular to the ground at the rear end portion of the cargo box 13. A rear end portion of the side upper member 32 may be connected to an upper end portion of the D post 34.

Meanwhile, the lower end portion of the D post 34 may be connected to an end portion of the fourth floor member 38 disposed in the width direction of the vehicle 1 at the rearmost among the floor members 35, 36, 37, and 38. In other words, the fourth floor member 38 may be disposed in the width direction of the vehicle 1, and both end portions of the fourth floor member 38 may be each connected to the D post 34 disposed at the rear end portion of the cargo box 13.

The D post 34 and the fourth floor member 38 may be connected to form a ‘U’-shaped structure, and the rear end portion of the side upper member 32 may be connected to the upper end portion of the D post 34.

Therefore, a front end portion of the side upper member 32 may be supported by a structure which is formed by the front side member 33 and the first floor member 35, the middle portion of the side upper member 32 may be supported by the third floor member 37, and the rear end portion of the side upper member 32 may be supported by a structure formed by the D post 34 and the fourth floor member 38, resulting in improving the rigidity of the side upper member 32.

As described above, because the front end portion, middle portion, and rear end portion of the side upper member 32 may be fastened without being separated from the reinforcement members 33, 34, and 37 perpendicular to the cargo box 13, even when the external force such as a collision is the upper side portion of the cargo box 13 provided with the side upper member 32, it is possible to prevent or reduce the deformation of the cargo box 13.

As another exemplary embodiment of the present disclosure, a hook rail 39 may be further provided in the longitudinal direction of the vehicle 1 under the side upper member 32. A lower end portion of the side upper member 32, an upper end portion of the third floor member 37, and the upper end portion of the side internal panel 22 may be connected to the hook rail 39. A hook 15 may be provided directly on the side internal panel 22, but the hook rail 39 may be provided under the side upper member 32, and the hook 15 may be provided on the hook rail 39.

Meanwhile, the front end portion of the side upper member 32 may be supported by a front guard 31. The front guard 31 may be disposed in the width direction of the vehicle 1 at an upper end portion of the front portion of the cargo box 13. Because both end portions of the front guard 31 may be each connected to the side upper member 32, the front end portion of the side upper member 32 may be supported by not only a structure formed by the front side member 33 and the first floor member 35, but also by the front guard 31.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A side structure of a cargo box of a vehicle including a cabin where occupants board, the side structure comprising:
a side external panel mounted outside the cargo box to form an exterior of the cargo box provided behind the cabin;
a side internal panel mounted inside the side external panel in the cargo box;
a side upper member mounted in a longitudinal direction of the vehicle on an upper end portion of the side external panel or an upper end portion of the side internal panel; and
a plurality of reinforcement members mounted between the side external panel and the side internal panel,
wherein upper end portions of reinforcement members are connected to the side upper member.

2. The side structure of claim 1, wherein the side upper member includes an open lower portion.

3. The side structure of claim 2, wherein the side upper member includes a cross section in which an upper portion and first and second side portions of the side upper member are bent at a right angle.

4. The side structure of claim 1,
wherein the plurality of reinforcement members includes a front side member mounted at a front end portion of a side portion of the cargo box, and
wherein an upper end portion of the front side member is connected to a front end portion of the side upper member.

5. The side structure of claim 4, wherein a lower end portion of the front side member is connected to each of first and second end portions of a first floor member mounted at a lower end portion of a front portion of the cargo box.

6. The side structure of claim 5, further including a second floor member spaced apart from the first floor member to a rear side of the vehicle and connected to a wheel house.

7. The side structure of claim 1,
wherein the plurality of reinforcement members includes a third floor member including a middle portion formed in a width direction of the cargo box and disposed on a floor of the cargo box, and formed to be bent upward between the side external panel and the side internal panel, and
wherein an upper end portion of the third floor member is connected to the side upper member.

8. The side structure of claim 7, further including:
a hook rail provided in the longitudinal direction of the vehicle under the side upper member,
wherein a lower end portion of the side upper member, the upper end portion of the third floor member, and the upper end portion of the side internal panel are connected to the hook rail.

9. The side structure of claim 1,
wherein the plurality of reinforcement members includes a D post on which a tail gate is provided at a rear end portion of the cargo box, and
wherein an upper end portion of the D post is connected to a rear end portion of the side upper member.

10. The side structure of claim 9, wherein a lower end portion of the D post is connected to an end portion of a fourth floor member mounted in a width direction of the vehicle at a lower end portion of a rear portion of the cargo box.

11. The side structure of claim 1, further including a front guard disposed in a width direction of the vehicle at an upper end portion of a front portion of the cargo box and including first and second end portions each connected to the side upper member.

12. A side structure of a cargo box of a vehicle including a cabin where occupants board, the side structure comprising:
a side external panel mounted outside the cargo box to form an exterior of the cargo box provided behind the cabin;
a side internal panel mounted inside the side external panel in the cargo box;
a side upper member mounted in a longitudinal direction of the vehicle on an upper end portion of the side external panel or an upper end portion of the side internal panel; and
a plurality of reinforcement members mounted between the side external panel and the side internal panel, and
a hook rail provided in the longitudinal direction of the vehicle under the side upper member.

13. The side structure of claim 12, wherein the plurality of reinforcement members includes:
a front side member mounted at a front end portion of a side portion of the cargo box; and
a third floor member including a middle portion formed in a width direction of the cargo box and disposed on a floor of the cargo box, and formed to be bent upward between the side external panel and the side internal panel.

14. The side structure of claim 13, further including:
a first floor member mounted at a lower end portion of a front portion of the cargo box; and
a second floor member spaced apart from the first floor member to the rear of the vehicle and connected to a wheel house.

15. The side structure of claim 14, wherein a lower end portion of the side upper member, an upper end portion of the third floor member, and the upper end portion of the side internal panel are connected to the hook rail.

16. The side structure of claim 13, wherein the plurality of reinforcement members further includes a D post on which a tail gate is provided at a rear end portion of the cargo box.

17. The side structure of claim 16, wherein the plurality of reinforcement members further includes a fourth floor member provided at the rear end portion of the cargo box.

18. The side structure of claim 17, wherein a lower end portion of the D post is connected to an end portion of the fourth floor member.

19. The side structure of claim 13, further including:
a front guard disposed in a width direction of the vehicle at an upper end portion of a front portion of the cargo box,
wherein a front end portion of the side upper member is supported by the front guard including first and second end portions each connected to the side upper member.

20. The side structure of claim 19, wherein the first and second end portions of the front guard are connected to the side upper member, and the front end portion of the side upper member is supported by not only a structure formed by the front side member and the first floor member, but also by the front guard.
